(19) United States
(12) Patent Application Publication
(10) Pub. No.: US 2026/0150165 A1
(43) Pub. Date: May 28, 2026

(54) CONTROLLERS FOR CONTROLLING SWITCHING CONVERTERS

(71) Applicant: O2Micro, Inc., Santa Clara, CA (US)

(72) Inventors: Kaiping RAN, Fremont, CA (US); Weiwei SONG, Wuhan (CN)

(21) Appl. No.: 19/289,853

(22) Filed: Aug. 4, 2025

Related U.S. Application Data
(60) Provisional application No. 63/725,512, filed on Nov. 26, 2024.

(30) Foreign Application Priority Data
May 22, 2025 (CN) 202510669758.2

(51) Int. Cl. H05B 45/3725; H02M 1/32; H02M 3/156; H05B 45/397; H05B 45/50

(52) U.S. Cl. CPC H05B 45/3725; H02M 1/32; H02M 3/156; H05B 45/397; H05B 45/50

(57) ABSTRACT

A controller includes a drive terminal, a multi-function terminal, and control circuitry coupled to the drive terminal and the multi-function terminal. The drive terminal provides a drive signal to alternately turn on and turn off a power switch in a switching converter at a frequency of the drive signal. In a normal mode, the multi-function terminal provides a control current to control the frequency of the drive signal. In a protection mode, the multi-function terminal provides a control voltage indicating that an abnormal condition is present in a system including the controller. The control circuitry activates an alert signal if the abnormal condition is detected in the normal mode. The control circuitry also switches operation to the protection mode and generates the control voltage at the multi-function terminal when the alert signal is active.

### RELATED APPLICATIONS

This application claims priority to the U.S. Provisional Application with Ser. No. 63/725,512, filed on Nov. 26, 2024, and claims benefit under 35 U.S.C. § 119(a) to Application No. 202510669758.2, filed with the State Intellectual Property Office of the People's Republic of China on May 22, 2025, which are hereby incorporated by reference in their entireties.

### BACKGROUND

FIG. 1 illustrates a block diagram of a conventional light emitting diode (LED) driving system 100. The LED driving system 100 includes an LED driver controller 102, a switching converter 104, and an LED string 106. The LED driver controller 102 controls the switching converter 104 to power the LED string 106 by alternately turning on and off a switch Q_{SW} in the switching converter 104. The LED driver controller 102 is integrated into a standard 8-pin package. The LED driver controller 102 includes eight pins labeled “VCC,” “ADIM,” “PWM,” “VREF,” “DRV,” “ISEN,” “RT,” and “GND,” respectively. The pin VCC is configured to receive the power supply for the LED driver controller 102. The pin ADIM is configured to receive a signal that determines a target level for the LED current. The pin PWM is configured to receive a pulse-width-modulation (PWM) signal that controls the on time and off time of the LED string 106. The pin VREF is configured to connect an output terminal of a low dropout regulator (LDO) in the LED driver controller 102 to ground via a filter capacitor C_{REF} so that the LDO can provide a stable output voltage to power internal circuit blocks in the LED driver controller 102. The pin DRV is configured to provide a drive signal to control the switch Q_{SW} in the switching converter 104. The pin ISEN is configured to sense the current of the LED string 106. The pin RT is coupled to ground GND through a resistor R_{RT} and is configured to set an operating frequency of the LED driver controller 102 (e.g., a frequency of the drive signal) using the resistor R_{RT}. The pin GND is coupled to ground. As such, all the pins of the LED driver controller 102 are configured to perform respective functions. However, it would be beneficial if the LED driver controller 102 is also capable of detecting an abnormal condition of the system 100 (e.g., including an over-current condition, an open-LED condition, a MOSFET short-circuit condition, an over-temperature condition, etc.) and reporting the abnormal condition to a central controller of the abnormal condition if the abnormal condition is detected.

In a conventional solution, the filter capacitor C_{REF} is inside the integrated circuit (IC) package of the LED driver controller 102 and the pin VREF is repurposed for reporting an abnormal condition. However, the filter capacitor C_{REF} is relatively large and can significantly increase the die size and the cost of the IC.

In another conventional solution, the resistor R_{RT} is inside the IC package and the pin RT is repurposed for reporting an abnormal condition. However, because the operating frequency of the LED driver controller 102 is determined by the resistor R_{RT}, integrating the resistor R_{RT} inside the IC package can reduce the flexibility of frequency selection.

In yet another conventional solution, external detection circuits, outside of the LED driver controller 102, are added in the system 100 to detect an abnormal condition. However, the external detection circuits may need to be integrated into another IC package or multiple IC packages that include multiple pins for performing the detection of abnormal conditions and reporting an abnormal condition if detected, which can significantly increase the cost and the size of the printed circuit board (PCB) for the system 100. Additionally, the external detection circuits cannot detect an abnormal condition such as an over-temperature condition inside the LED driver controller 102.

In yet another conventional solution, the LED driver controller 102 is integrated into another type of package that includes more than eight pins, e.g., a standard 10-pin package. However, this may increase the cost and the size of the PCB for the system 100.

### SUMMARY

Embodiments of the present invention provide a solution to the problems described above.

In an embodiment, a controller includes a drive terminal, a multi-function terminal, and control circuitry coupled to the drive terminal and the multi-function terminal. The drive terminal provides a drive signal to alternately turn on and turn off a power switch in a switching converter at a frequency of the drive signal. In a normal mode, the multi-function terminal provides a control current to control the frequency of the drive signal. In a protection mode, the multi-function terminal provides a control voltage indicating that an abnormal condition is present in a system including the controller. The control circuitry activates an alert signal if the abnormal condition is detected in the normal mode. The control circuitry also switches operation to the protection mode and generates the control voltage at the multi-function terminal when the alert signal is active.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a block diagram of a conventional LED driving system.

FIG. 2A illustrates a block diagram of an example of a power conversion system, in an embodiment of the present invention.

FIG. 2B illustrates a block diagram of an example of an LED driving system, in an embodiment of the present invention.

FIG. 3A illustrates a block diagram of an example of a controller, in an embodiment of the present invention.

FIG. 3B illustrates a circuit diagram of an example of a controller, in an embodiment of the present invention.

FIG. 3C illustrates a circuit diagram of an example of a controller, in an embodiment of the present invention.

FIG. 3D illustrates a circuit diagram of an example of a controller, in an embodiment of the present invention.

FIG. 4A illustrates a block diagram of an example of an external detection circuit coupled to a multi-function terminal of a controller, in an embodiment of the present invention.

FIG. 4B illustrates a circuit diagram of an example of an external detection circuit coupled to a multi-function terminal of a controller, in an embodiment of the present invention.

FIG. 4C illustrates a circuit diagram of an example of an external detection circuit coupled to a multi-function terminal of a controller, in an embodiment of the present invention.

FIG. 5 illustrates a flowchart of an example of a method for controlling a switching converter, in an embodiment of the present invention.

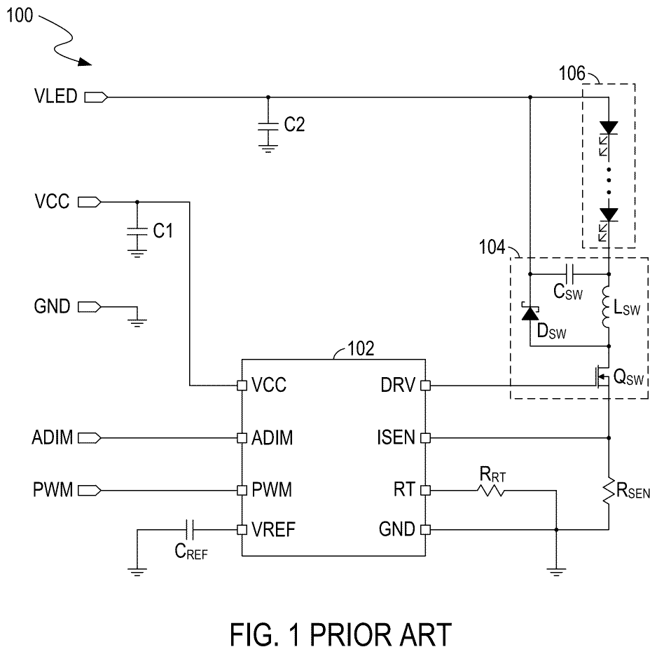

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications, and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

An embodiment according to the present invention provides a power conversion system (e.g., including an LED driving system). In the power conversion system, a controller, e.g., an LED driver controller, can control a switching converter that powers a load, e.g., including one or more LEDs. The controller can operate in a normal mode if no abnormal condition is detected, or operate in a protection mode if an abnormal condition is detected. The controller includes a multi-function terminal (e.g., a pin labeled “RT-STA”) configured to set an operating frequency of the controller if the controller is in the normal mode, and configured to output a signal indicative of an abnormal condition of the power conversion system if the controller is in the protection mode. The abnormal condition can include, but is not limited to, an over-current condition of the load, an open-circuit condition of the load (e.g., including an open-LED condition), a MOSFET short-circuit condition of the switching converter, and an over-temperature condition of the controller. As a result, compared to the conventional LED driver controller 102, the controller in an embodiment of the present invention can detect abnormal conditions in the power conversion system and report an abnormal condition if detected without significantly increasing the cost and the size of the power conversion system, reducing the flexibility of frequency selection, or increasing the pin number of the controller.

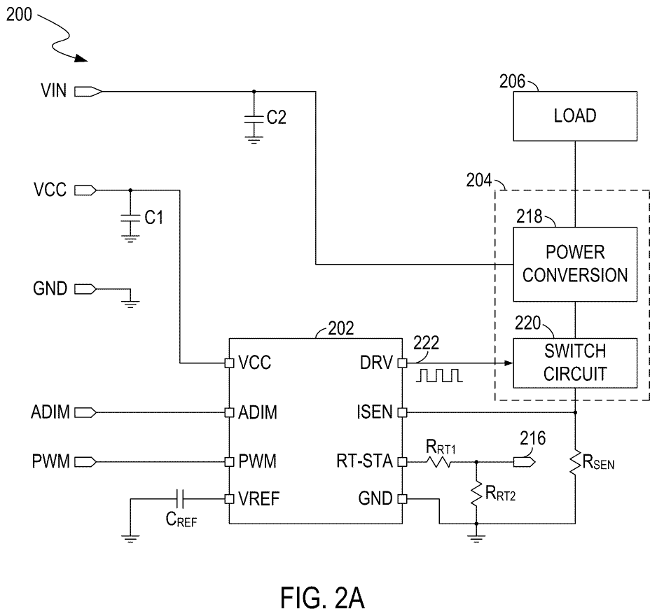

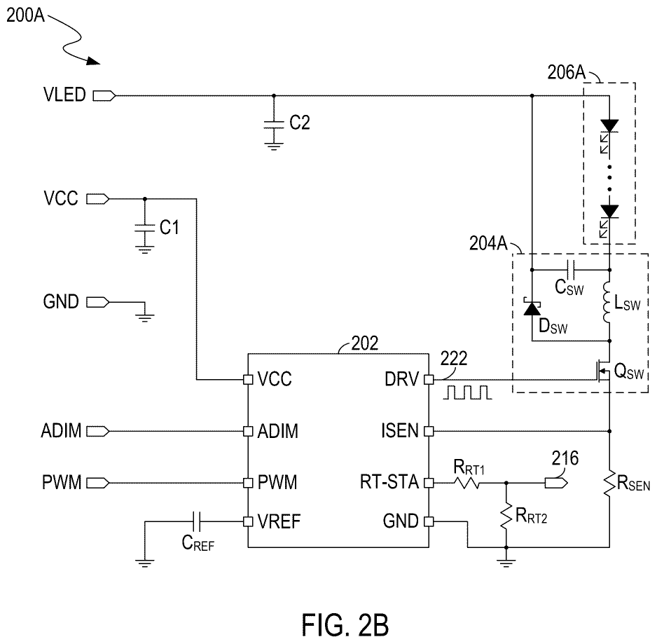

FIG. 2A illustrates a block diagram of an example of a power conversion system 200, in an embodiment of the present invention. In the power conversion system 200, a switching converter 204 can convert input power received at a terminal VIN to output power to power a load 206. The switching converter 204 can include a power conversion circuit 218 and a switch circuit 220 (e.g., including one or more switches). A controller 202 can control the switching converter 204 to perform the power conversion by controlling the switch circuit 220.

The switching converter 204 can include a circuit structure in which a power conversion circuit is coupled to one or more switches and the power conversion circuit converts input power to output power when the one or more switches are turned on and off alternately. In some embodiments, the switching converter 204 includes a buck converter. In some other embodiments, the switching converter 204 includes a boost converter. For example, the switching converter 204 can, but not necessarily, include a circuit structure of the switching converter 204A shown in FIG. 2B. More specifically, in the example of FIG. 2B, the power conversion system 200A includes a system for driving a light source 206A including one or more LEDs. The switching converter 204A can include an inductive component L_{SW}, a capacitive component C_{SW}, a power switch Q_{SW} (e.g., a metal-oxide semiconductor field-effect transistor, hereinafter MOSFET), and a diode D_{SW}. The switching converter 204A can convert an input power received at a terminal VLED to an output power to power a load (e.g., the light source 206A including one or more LEDs) when the power switch Q_{SW} in the switching converter 204A is turned on and off alternately.

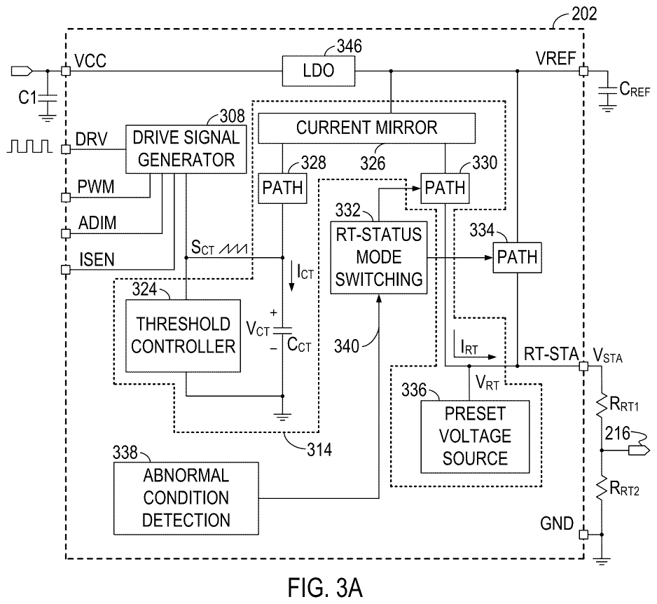

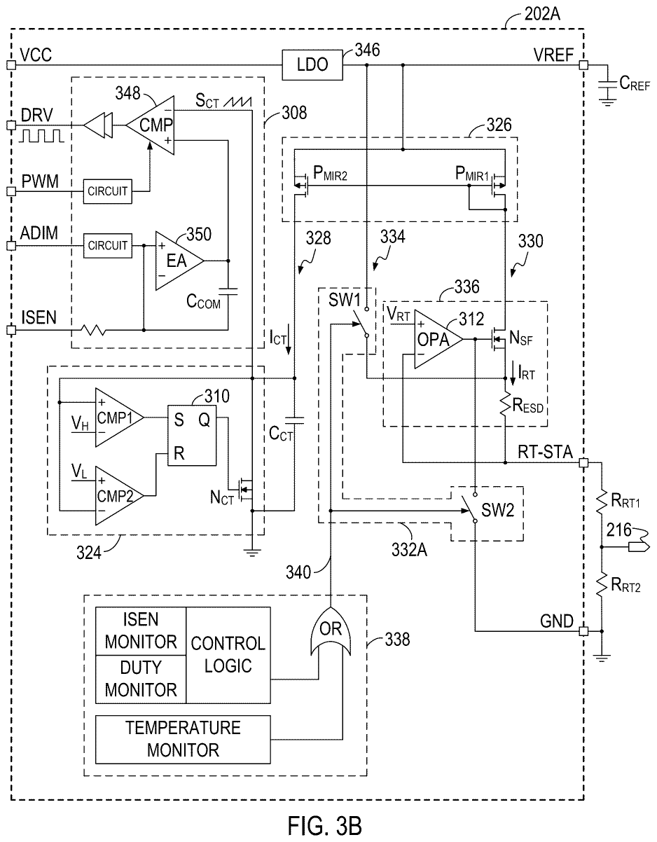

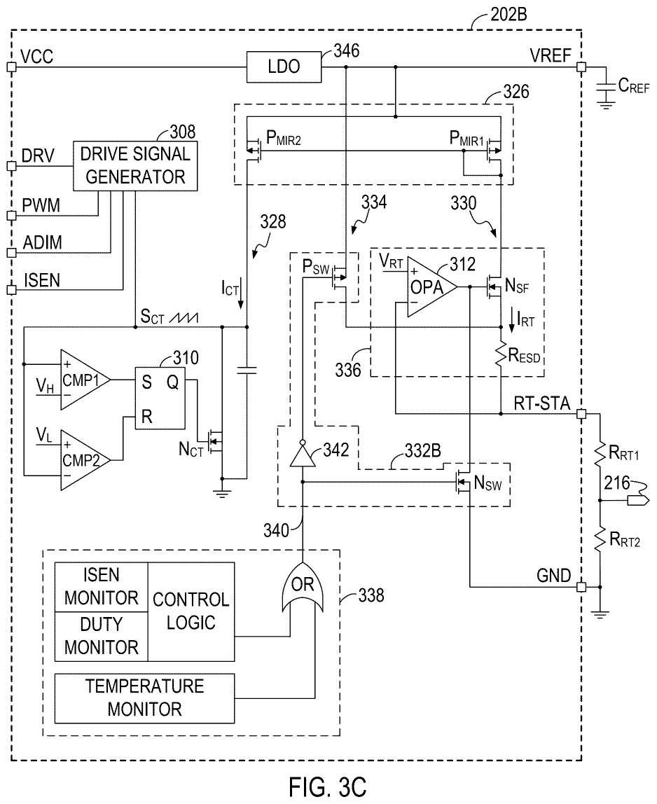

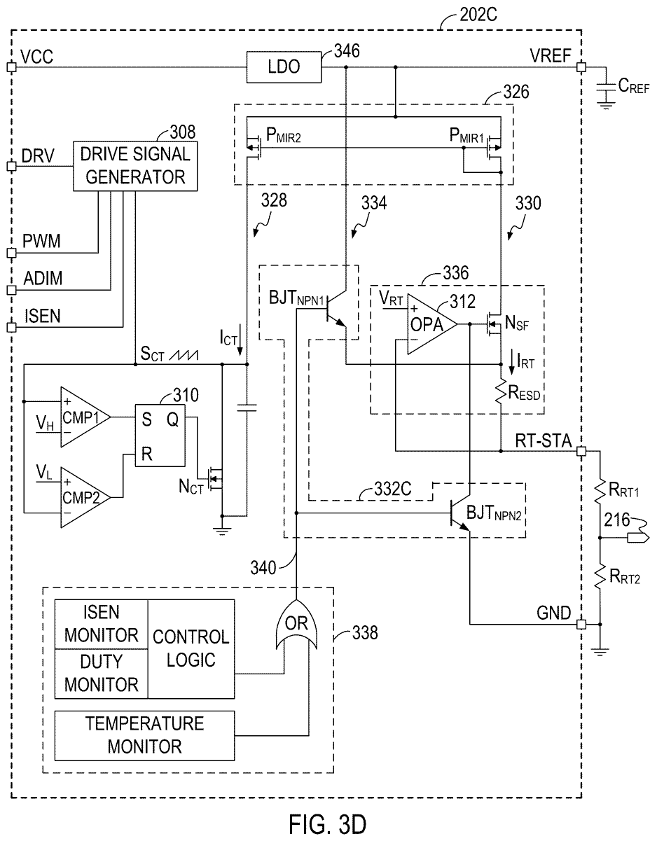

In some embodiments, the controller 202 can operate in a mode of a set of modes including a normal mode and a protection mode. The controller 202 can operate in the normal mode if the controller 202 does not detect any abnormal condition, or operate in the protection mode if the controller 202 detects an abnormal condition. In some embodiments, the abnormal condition can include, but is not limited to, an over-current condition of the load 206, an open-circuit condition of the load 206 (e.g., including an open-LED condition), a MOSFET short-circuit condition of a power switch (e.g., Q_{SW} in FIG. 2B), and an over-temperature condition of the controller 202. As shown in FIG. 2A, the controller 202 includes a drive terminal labeled “DRV” (e.g., including a pin) configured to provide a drive signal 222 to alternately turn on and off a power switch (e.g., Q_{SW} in FIG. 2B) in the switch circuit 220 at a frequency F_{DRV}. The controller 202 also includes a multi-function terminal labeled “RT-STA” (e.g., including a pin). In the normal mode, the multi-function terminal RT-STA can provide a control current, e.g., a current I_{RT} shown in FIG. 3A, to control the frequency F_{DRV} of the drive signal 222. In some embodiments, resistance of a resistive circuit (e.g., including resistors R_{RT1} and R_{RT2} shown in FIG. 2A) can determine a level of the control current I_{RT} and therefore determine the frequency F_{DRV} of the drive signal 222. In the protection mode, the multi-function terminal RT-STA can provide a control voltage V_{STA} indicating that an abnormal condition is present in the power conversion system 200. The resistive circuit can provide a signal indicative of the control voltage V_{STA} at a terminal 216.

FIG. 3A illustrates a block diagram of an example of the controller 202, in an embodiment of the present invention. FIG. 3A is described in combination with FIG. 2A and FIG. 2B. In some embodiments, control circuity in the controller 202 includes an internal voltage source such as a low dropout (LDO) regulator 346 configured to power internal circuitry of the controller 202, a ramp-signal generation circuit 314 configured to generate a ramp signal S_{CT}, a drive signal generator 308 configured to generate the drive signal 222 according to the ramp signal S_{CT}, an abnormal-condition detection circuit 338 configured to detect an abnormal condition of the power conversion system 200 and activate an alert signal 340 if the abnormal condition is detected, and a mode-switching circuit 332 configured to switch an operation mode of the controller 202 from a normal mode to a protection mode if the alert signal 340 is activated. In some embodiments, if the detection circuit 338 does not detect any abnormal condition, then the alert signal 340 is inactive. When the alert signal 340 is inactive, the controller 202 operates in the normal mode and generates a control current I_{RT} to flow through the multi-function terminal RT-STA. If the detection circuit 338 detects an abnormal condition, then the alert signal 340 is activated. When the alert signal 340 is activated, the controller 202 operates in the protection mode and generates a control voltage V_{STA} at the multi-function terminal RT-STA.

More specifically, as shown in FIG. 3A, the ramp-signal generation circuit 314 can include a current mirror 326, a first path 330, a preset voltage source 336, a second path 328, a capacitive component C_{CT}, and a threshold controller 324. The current mirror 326 is coupled to the multi-function terminal RT-STA through the first path 330 and coupled to the capacitive component C_{CT} through the second path 328. The current mirror 326 can provide a control current I_{RT} to the resistive circuit (e.g., including resistors R_{RT1} and R_{RT2}) through the first path 330 and the multi-function terminal RT-STA, and generate a charging current I_{CT} to charge the capacitive component C_{CT} through the second path 328. The first path 330 can include the input branch (or the reference side) of the current mirror 326, and the second path 328 can include the output branch (or the mirrored side) of the current mirror 326. Thus, the second path 328 can be enabled by enabling the first path 330, and disabled by disabling the first path 330. The charging current I_{CT} through the second path 328 includes a proportional copy of the control current I_{RT} through the first path. For example, the current mirror 326 may include a first MOSFET (e.g., a p-channel MOSFET P_{MIR1} shown in FIG. 3B) coupled to the first path 330 and a second MOSFET (e.g., a p-channel MOSFET P_{MIR2} shown in FIG. 3B) coupled to the second path 328. A gate-source voltage of the first MOSFET is equal to or approximately equal to a gate-source voltage of the second MOSFET. The first MOSFET has a first width-to-length ratio WLR1. The second MOSFET has a second width-to-length ratio WLR2. Thus, the charging current I_{CT} can be given by: I_{CT}=I_{RT}*(WLR2/WRL1). The preset voltage source 336 is coupled to the first path 330. The preset voltage source 336 can apply a preset voltage V_{RT} on the resistive circuit (e.g., including resistors R_{RT1} and R_{RT2}) through the multi-function terminal RT-STA when the first path 330 is enabled. The first path 330 is enabled when and while the alert signal 340 is inactive. The control current I_{RT} is determined by the preset voltage V_{RT} and resistance of the resistive circuit. For example, the control current I_{RT} can be given by: I_{RT}=V_{RT}/(R_{RT1}+R_{RT2}). The threshold controller 324 is coupled to the second path 328 and the capacitive component C_{CT}. As mentioned above, the charging current I_{CT} can charge the capacitive component C_{CT}, and therefore a ramp voltage V_{CT} on the capacitive component C_{CT} can increase. If the ramp voltage V_{CT} increases to a first threshold V_{H} (e.g., a preset voltage reference), then the threshold controller 324 discharges the capacitive component C_{CT} to reduce the ramp voltage V_{CT}. If the ramp voltage V_{CT} decreases to a second threshold V_{L} (e.g., a preset voltage reference), then the threshold controller 324 allows the charging current I_{CT} to charge the capacitive component C_{CT}. As a result, the ramp-signal generation circuit 314 can generate a ramp signal S_{CT}, e.g., including the ramp voltage V_{CT}, with a frequency that is determined by the charging current I_{CT}. For example, the frequency of the ramp voltage V_{CT} can increase if the charging current I_{CT} increases (or the resistance R_{RT1}+R_{RT2} decreases), or decrease if the charging current I_{CT} decreases (or the resistance R_{RT1}+R_{RT2} increases). In some embodiments, the frequency F_{DRV} of the drive signal 222 includes the frequency of the ramp voltage V_{CT}. The frequency of the ramp voltage V_{CT} can be referred to as an operating frequency of the controller 202.

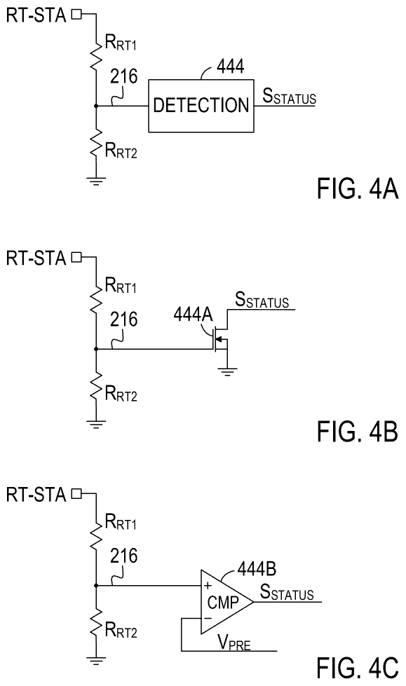

Additionally, as shown in FIG. 3A, the third path 334 is coupled to the multi-function terminal RT-STA, and can provide a control voltage V_{STA} to the resistive circuit (e.g., including resistors R_{RT1} and R_{RT2}) through the multi-function terminal RT-STA when the third path 334 is enabled. In an embodiment, the control voltage V_{STA} is provided by a reference voltage source (e.g., including the LDO 346) and is greater than the preset voltage V_{RT} from the preset voltage source 336. The detection circuit 338 can generate the alert signal 340 and control the alert signal by detecting an abnormal condition of the power conversion system 200. The mode-switching circuit 332 is coupled to the first path 330, the third path 334, and the detection circuit 338. When and while the alert signal 340 is inactive, the first path 330 is enabled and the third path 334 is disabled. The mode-switching circuit 332 can disable the first path 330 and enable the third path 334 when and while the alert signal 340 is activated. The second path 328 can be enabled by enabling the first path 330, and disabled by disabling the first path 330. In other words, in some embodiments, while in the normal mode (while the alert signal 340 is inactive), the mode-switching circuit 332 can enable the first and second paths 330 and 328 and disable the third path 334. While in the protection mode (when the alert signal 340 is active), the mode-switching circuit 332 can disable the first and second paths 330 and 328 and enable the third path 334 in response to receiving or detecting the alert signal 340. Thus, when an abnormal condition is detected, the power conversion process is disabled (by disabling the first and second paths 330 and 328) and the controller 202 is switched from the normal mode to the protection mode (by enabling the third path 334). In the protection mode, a signal S_{STATUS} (see FIGS. 4A, 4B, and 4C) indicative of the control voltage V_{STA} at the terminal 216 is generated when the third path 334 is enabled, and that signal S_{STATUS} is used for informing an external device, e.g., a central controller, a host device, or a microcontroller, that an abnormal condition is present in the power conversion system (e.g., 200 or 200A).

FIG. 3B illustrates a circuit diagram of an example of a controller 202A, in an embodiment of the present invention. The controller 202A can be an embodiment of the controller 202. FIG. 3B is described in combination with FIG. 2A, FIG. 2B, and FIG. 3A.

As shown in FIG. 3B, the first path 330 includes a transistor N_{SF} (e.g., an n-channel MOSFET) configured to conduct the control current I_{RT} when the transistor N_{SF} is turned on. The mode-switching circuit 332A (e.g., an embodiment of the mode-switching circuit 332) includes a mode switch SW1. The mode-switching circuit 332A may also include, but not necessarily, a switch SW2. The mode switch SW1 is coupled to the detection circuit 338 and the third path 334, and configured to connect the multi-function terminal RT-STA to a reference voltage source (e.g., the LDO 346) through the third path 334 when the alert signal 340 is activated. When the multi-function terminal RT-STA is connected to the reference voltage source 346, the transistor N_{SF} in the first path 330 is turned off.

In some embodiments, the preset voltage source 336 includes an operational amplifier 312 that includes a first input terminal (e.g., an inverting input terminal) coupled to the multi-function terminal RT-STA, a second input terminal (e.g., a non-inverting input terminal) configured to receive a preset voltage V_{RT}, and an output terminal coupled to the transistor N_{SF}. When the mode switch SW1 is turned off, the operational amplifier 312 can apply the preset voltage V_{RT} to the multi-function terminal RT-STA by controlling the transistor N_{SF} (e.g., due to the virtual short phenomenon in the operational amplifier 312). When the mode switch SW1 is turned on, a voltage at the inverting input terminal of the operational amplifier 312 is pulled up through a resistor R_{ESD} and the mode switch SW1 to be V_{STA} and greater than the preset voltage V_{RT}. As such, the transistor N_{SF} is turned off by the operational amplifier 312. When the mode switch SW1 is turned on, the switch SW2 can also be turned on to ensure that the transistor N_{SF} is turned off.

Additionally, in some embodiments, the threshold controller 324 can set a peak and a trough of the ramp signal S_{CT}. In the example of FIG. 3B, when the ramp signal S_{CT} increases to a first threshold V_{H}, a comparator CMP1 can set a flip-flop 310 to turn on a transistor N_{CT} to discharge the capacitive component C_{CT}. Hence, the ramp signal S_{CT} decreases. When the ramp signal S_{CT} decreases to a second threshold V_{H}, a comparator CMP2 can reset the flip-flop 310 to turn off the transistor N_{CT} so that the capacitive component C_{CT} is charged by the charging current I_{CT}. Hence, the ramp signal S_{CT} increases. In the drive signal generator 308, a comparator 348 compares the ramp signal S_{CT} with a compensation signal from an error amplifier 350 and generates a drive signal (e.g., the drive signal 222 shown in FIG. 2A or FIG. 2B) according to the comparison. The compensation signal can indicate a difference between a current of a load (e.g., including an LED current of the LEDs 206A in FIG. 2B) and a target level of the current. As a result, the drive signal generator 308 generates a drive signal with a duty cycle determined by the difference between the current of the load and the target level of the current and at a frequency of the ramp signal S_{CT}.

In operation in some embodiments, when the detection circuit 338 does not detect an abnormal condition, the alert signal 340 is inactive. The switches SW1 and SW2 are turned off. The operational amplifier 312 sets a voltage at the multi-function terminal RT-STA to be the preset voltage V_{RT}, and therefore the controller 202A can generate a control current I_{RT} (e.g., given by I_{RT}=V_{RT}/(R_{RT1}+R_{RT2}). The control current I_{RT} is provided such that a ramp signal S_{CT} is generated to control a drive signal (e.g., the drive signal 222 shown in FIG. 2A or FIG. 2B). The control current I_{RT} controls a frequency of the ramp signal S_{CT} and therefore controls a frequency F_{DRV} of the drive signal 222. If the detection circuit 338 detects an abnormal condition of the power conversion system (e.g., 200 or 200A), the detection circuit 338 activates the alert signal 340 to turn on the switches SW1 and SW2. Thus, the multi-function terminal RT-STA is connected to the LDO 346 through the resistor R_{ESD} and the switch SW1, and a control voltage V_{STA} (e.g., greater than the preset voltage V_{RT}) is generated at the multi-function terminal RT-STA.

FIG. 3C illustrates a circuit diagram of an example of a controller 202B, in an embodiment of the present invention. The controller 202B can be an embodiment of the controller 202. FIG. 3C is described in combination with FIG. 2A, FIG. 2B, FIG. 3A, and FIG. 3B. As shown in FIG. 3C, the controller 202B is similar to the controller 202A in FIG. 3B except that the mode-switching circuit 332B of the controller 202B in FIG. 3C further includes an inverter 342 coupled to the mode switch such as a p-channel MOSFET P_{SW}. In the example of FIG. 3C, the alert signal 340 is active-high. However, the invention is not so limited; in another example not shown in FIG. 3C, the alert signal 340 is active-low. In this example, in the mode-switching circuit, the mode switch (e.g., the p-channel MOSFET P_{SW)} can receive the alert signal 340 directly, and the switch (e.g., the n-channel MOSFET N_{SW}) can receive the alert signal 340 through an inverter.

FIG. 3D illustrates a circuit diagram of an example of a controller 202C, in an embodiment of the present invention. The controller 202C can be an embodiment of the controller 202. FIG. 3D is described in combination with FIG. 2A FIG. 2B, FIG. 3A, and FIG. 3B. As shown in FIG. 3D, the controller 202C is similar to the controller 202A in FIG. 3B. In the mode-switching circuit 332C in FIG. 3D, the NPN transistor BJT_{NPN1} can be an embodiment of the abovementioned mode switch SW1, and the NPN transistor BJT_{NPN2} can be an embodiment of the abovementioned switch SW2.

FIG. 4A illustrates a block diagram of an example of an external detection circuit 444 coupled to a multi-function terminal RT-STA of a controller, e.g., 202, 202A, 202, or 202C, in an embodiment of the present invention. FIG. 4A is described in combination with FIG. 2A, FIG. 2B, FIG. 3A, FIG. 3B, FIG. 3C, and FIG. 3D. In some embodiments, the detection circuit 444 can be a circuit in a device such as a central controller, a host device, or a microcontroller. In the example of FIG. 4A, the detection circuit 444 is coupled to the terminal 216 between the resistors R_{RT1} and R_{RT2} and receives a scaled-down voltage of the control voltage V_{STA} at the multi-function terminal RT-STA. However, the invention is not so limited. In another example not shown in FIG. 4A, the detection circuit 444 can be coupled to the multi-function terminal RT-STA directly and receives the control voltage V_{STA}.

The detection circuit 444 can include a circuit that is capable of determining whether an abnormal condition is present in the power conversion system, e.g., 200 or 200A, by detecting a voltage at the multi-function terminal RT-STA. For example, when there is no abnormal condition present in the power conversion system, the voltage at the multi-function terminal RT-STA can be equal to the above-mentioned preset voltage V_{RT}. When an abnormal condition of the power conversion system is detected, the voltage at the multi-function terminal RT-STA can be equal to the control voltage V_{STA} that is greater than the preset voltage V_{RT}. In the example of FIG. 4B, the detection circuit 444 includes an n-channel MOSFET 444A. The n-channel MOSFET 444A can be turned off if the voltage at the multi-function terminal RT-STA is equal to the preset voltage V_{RT}, and can be turned on if the voltage at the multi-function terminal RT-STA is equal to the control voltage V_{STA}. Accordingly, a signal S_{STATUS} at the drain terminal of the n-channel MOSFET 444A can be generated to inform the above-mentioned central controller, host device, or microcontroller of whether an abnormal condition is present in the power conversion system. In the example of FIG. 4C, the detection circuit 444 includes a comparator 444B. The comparator 444B can output a logic-low signal S_{STATUS} if the voltage at the multi-function terminal RT-STA is equal to the preset voltage V_{RT}, or output a logic-high signal S_{STATUS} if the voltage at the multi-function terminal RT-STA is equal to the control voltage V_{STA}. Accordingly, a signal S_{STATUS} output from the comparator 444B can be generated to inform the above-mentioned central controller, host device, or microcontroller of whether an abnormal condition is present in the power conversion system.

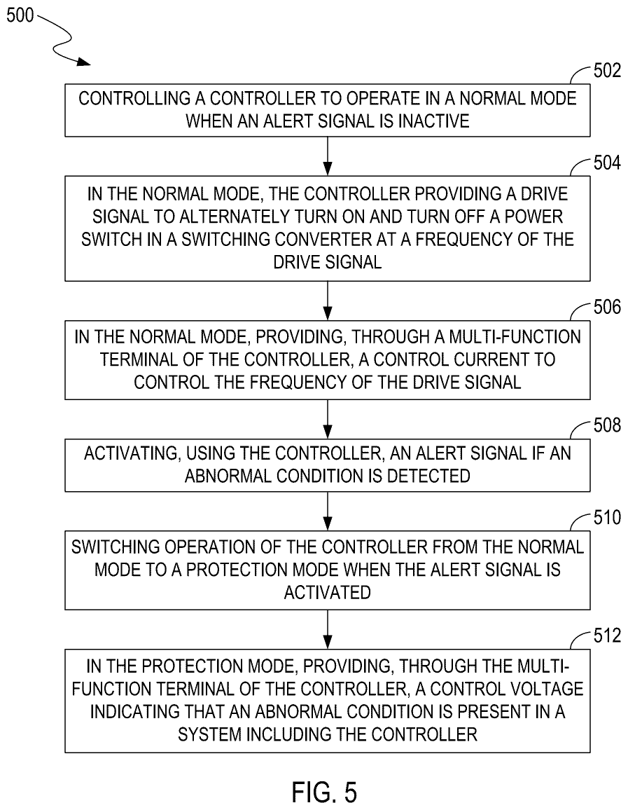

FIG. 5 illustrates a flowchart 500 of an example of a method for controlling a switching converter 204, in an embodiment of the present invention. FIG. 5 is described in combination with FIG. 2A, FIG. 2B FIG. 3A, FIG. 3B, FIG. 3C, FIG. 3D, FIG. 4A, FIG. 4B, and FIG. 4C.

At step 502, a controller (e.g., 202, 202A, 202B, or 202C) is controlled to operate in normal mode when an alert signal (e.g., 340) is inactive.

At step 504, in the normal mode, the controller provides a drive signal (e.g., 222) to alternately turn on and off a power switch (e.g., Q_{SW}) in a switching converter (e.g., 204) at a frequency F_{DRV} of the drive signal.

At step 506, in the normal mode, a control current (e.g., I_{RT}) is provided to a resistive circuit (e.g., including resistors R_{RT1} and R_{RT2}) through a multi-function terminal RT-STA of the controller to control the frequency F_{DRV} of the drive signal.

At step 508, the controller activates the alert signal if an abnormal condition is detected.

At step 510, the controller switches its operation from the normal mode to a protection mode when the alert signal is activated.

At step 512, in the protection mode, a control voltage V_{STA} is provided to the resistive circuit through the multi-function terminal of the controller to indicate that an abnormal condition is present in a power conversion system (e.g., 200 or 200A).

While the foregoing description and drawings represent embodiments of the present invention, it will be understood that various additions, modifications, and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A controller comprising:
a drive terminal configured to provide a drive signal to alternately turn on and turn off a power switch in a switching converter at a frequency of said drive signal;
a multi-function terminal, wherein in a normal mode, said multi-function terminal is configured to provide a control current to control said frequency of said drive signal, and wherein in a protection mode, said multi-function terminal is configured to provide a control voltage indicating that an abnormal condition is present in a system comprising said controller; and
control circuitry, coupled to said drive terminal and said multi-function terminal, configured to activate an alert signal if said abnormal condition is detected in said normal mode and to switch operation to said protection mode and generate said control voltage at said multi-function terminal when said alert signal is active.

2. The controller of claim 1, wherein said drive signal controls said switching converter to convert an input power to an output power to power a light source comprising at least one light emitting diode (LED) by alternately turning on and turning off said power switch.

3. The controller of claim 1, wherein said control circuitry comprises:
a current mirror coupled to said multi-function terminal through a first path and coupled to a capacitive component through a second path, wherein when said alert signal is inactive, said current mirror is configured to provide said control current to a resistive circuit through said first path and said multi-function terminal, and to generate a charging current to charge said capacitive component through said second path, and wherein said charging current comprises a proportional copy of said control current;
a preset voltage source, coupled to said first path, and configured to apply a preset voltage on said resistive circuit through said multi-function terminal when said alert signal is inactive, wherein said control current is determined by said preset voltage and resistance of said resistive circuit; and
a threshold controller, coupled to said second path and said capacitive component, configured to discharge said capacitive component if a ramp voltage on said capacitive component increases to a first threshold, and configured to allow said charging current to charge said capacitive component if said ramp voltage decreases to a second threshold, wherein a frequency of said ramp voltage is determined by said charging current, and wherein said frequency of said drive signal comprises said frequency of said ramp voltage.

4. The controller of claim 3, wherein said control circuitry further comprises:
a third path, coupled to said multi-function terminal, configured to provide said control voltage to said resistive circuit through said multi-function terminal when said alert signal is active;
a detection circuit configured to generate said alert signal and control said alert signal by detecting said abnormal condition; and
a mode-switching circuit, coupled to said first path, said third path, and said detection circuit, and configured to disable said first path and enable said third path when said alert signal is active.

5. The controller of claim 4, wherein in said normal mode, said mode-switching circuit disables said third path, and wherein in said protection mode, said mode-switching circuit disables said second path by disabling said first path.

6. The controller of claim 4, wherein said first path comprises a transistor configured to conduct said control current when said transistor is turned on, and wherein said mode-switching circuit comprises:
a mode switch, coupled to said detection circuit and said third path, configured to connect said multi-function terminal to a reference voltage source through said third path when said alert signal is activated, wherein said transistor is turned off when said multi-function terminal is connected to said reference voltage source.

7. The controller of claim 6, wherein said preset voltage source comprises an operational amplifier that comprises a first input terminal coupled to said multi-function terminal, a second input terminal configured to receive said preset voltage, and an output terminal coupled to said transistor, and wherein when said mode switch is turned off, said operational amplifier is configured to apply said preset voltage to said multi-function terminal by controlling said transistor.

8. A power conversion system comprising:
a switching converter configured to convert an input power to an output power to power a load when a power switch in said switching converter is turned on and turned off alternately; and
a controller coupled to said power switch, said controller comprising:
a drive terminal configured to provide a drive signal to alternately turn on and turn off said power switch at a frequency of said drive signal;
a multi-function terminal, wherein in a normal mode, said multi-function terminal is configured to provide a control current to control said frequency of said drive signal, and wherein in a protection mode, said multi-function terminal is configured to provide a control voltage indicating that an abnormal condition is present in said power conversion system; and
control circuitry, coupled to said drive terminal and said multi-function terminal, configured to activate an alert signal if said abnormal condition is detected in said normal mode and to switch operation to said protection mode and generate said control voltage at said multi-function terminal when said alert signal is active.

9. The power conversion system of claim 8, wherein said power conversion system comprises a system for driving at least one light emitting diode (LED), and wherein said load comprises said at least one LED.

10. The power conversion system of claim 8, wherein said control circuitry comprises:
a current mirror, coupled to said multi-function terminal through said a first path and coupled to a capacitive component through a second path, wherein when said alert signal is inactive, said current mirror is configured to provide said control current to a resistive circuit through said first path and said multi-function terminal, and generate a charging current to charge said capacitive component through said second path, and wherein said charging current comprises a proportional copy of said control current;
a preset voltage source, coupled to said first path, and configured to apply a preset voltage on said resistive circuit through said multi-function terminal when said alert signal is inactive, wherein said control current is determined by said preset voltage and resistance of said resistive circuit; and
a threshold controller, coupled to said second path and said capacitive component, configured to discharge said capacitive component if a ramp voltage on said capacitive component increases to a first threshold, and configured to allow said charging current to charge said capacitive component if said ramp voltage decreases to a second threshold, wherein a frequency of said ramp voltage is determined by said charging current, and wherein said frequency of said drive signal comprises said frequency of said ramp voltage.

11. The power conversion system of claim 10, wherein said control circuitry further comprises:
a third path, coupled to said multi-function terminal, configured to provide said control voltage to said resistive circuit through said multi-function terminal when said alert signal is active;
a detection circuit configured to generate said alert signal and control said alert signal by detecting said abnormal condition; and
a mode-switching circuit, coupled to said first path, said third path, and said detection circuit, and configured to disable said first path and enable said third path when said alert signal is active.

12. The power conversion system of claim 11, wherein in said normal mode, said mode-switching circuit disables said third path, and wherein in said protection mode, said mode-switching circuit disables said second path by disabling said first path.

13. The power conversion system of claim 11, wherein said first path comprises a transistor configured to conduct said control current when said transistor is turned on, and wherein said mode-switching circuit comprises:
a mode switch, coupled to said detection circuit and said third path, configured to connect said multi-function terminal to a reference voltage source through said third path when said alert signal is activated, wherein said transistor is turned off when said multi-function terminal is connected to said reference voltage source.

14. The power conversion system of claim 13, wherein said preset voltage source comprises an operational amplifier that comprises a first input terminal coupled to said multi-function terminal, a second input terminal configured to receive said preset voltage, and an output terminal coupled to said transistor, and wherein when said mode switch is turned off, said operational amplifier is configured to apply said preset voltage to said multi-function terminal by controlling said transistor.

15. A method comprising:
controlling a controller to operate in a normal mode when an alert signal is inactive;
in said normal mode, said controller providing a drive signal to alternately turn on and turn off a power switch in a switching converter at a frequency of said drive signal;
in said normal mode, providing, through a multi-function terminal of said controller, a control current to control said frequency of said drive signal;
activating, using said controller, said alert signal if an abnormal condition is detected;
switching operation of said controller from said normal mode to a protection mode when said alert signal is activated; and
in said protection mode, providing, through said multi-function terminal of said controller, a control voltage indicating that an abnormal condition is present in a system comprising said controller.

16. The method of claim 15, further comprising:
controlling said switching converter to convert an input power to an output power to power a light source comprising at least one light emitting diode (LED) by alternately turning on and off said power switch.

17. The method of claim 15, wherein said providing said control current to control said frequency of said drive signal comprises:
when said alert signal is inactive, providing said control current to a resistive circuit through a first path of a current mirror and said multi-function terminal;
when said alert signal is inactive, generating a charging current to charge a capacitive component through a second path of said current mirror, wherein said charging current comprises a proportional copy of said control current;
applying, using a preset voltage source coupled to said first path, a preset voltage on said resistive circuit through said multi-function terminal when said alert signal is inactive, wherein said control current is determined by said preset voltage and resistance of said resistive circuit;
discharging said capacitive component if a ramp voltage on said capacitive component increases to a first threshold; and
charging, using said charging current, said capacitive component if said ramp voltage decreases to a second threshold,
wherein a frequency of said ramp voltage is determined by said charging current, and wherein said frequency of said drive signal comprises said frequency of said ramp voltage.

18. The method of claim 17, further comprising:
disabling said first path when said alert signal is activated;
enabling a third path when said alert signal is activated; and
providing said control voltage to said resistive circuit through said third path and said multi-function terminal when said third path is enabled.

19. The method of claim 18, further comprising:
when said alert signal is inactive, conducting, using a transistor in said first path, said control current if said transistor is turned on,
connecting, using a mode switch, said multi-function terminal to a reference voltage source through said third path when said alert signal is activated; and
turning off said transistor when said multi-function terminal is connected to said reference voltage source.

20. The method of claim 19, wherein said preset voltage source comprises an operational amplifier that comprises a first input terminal coupled to said multi-function terminal and an output terminal coupled to said transistor, and wherein said method further comprises:
receiving said preset voltage at a second input terminal of said operational amplifier; and
when said mode switch is turned off, applying said preset voltage to said multi-function terminal by controlling said transistor using said operational amplifier.
